(19) United States
(12) Patent Application Publication
(10) Pub. No.: US 2026/0353236 A1
(43) Pub. Date: Nov. 5, 2026

(54) APPARATUSES AND METHODS FOR FACILITATING A MOBILITY AWARE TRAFFIC HANDLING FOR COMMUNICATION NETWORKS AND SYSTEMS

(71) Applicant: AT&T Mobility II LLC, Atlanta, GA (US)

(72) Inventors: Jason Young, Buford, GA (US); Ali Agha, PRINCETON, TX (US)

(73) Assignee: AT&T Mobility II LLC, Atlanta, GA (US)

(21) Appl. No.: 19/196,802

(22) Filed: May 2, 2025

(51) Int. Cl. H04W 36/32; H04W 24/08; H04W 64/00

(52) U.S. Cl. CPC H04W 36/324; H04W 24/08; H04W 64/00

(57) ABSTRACT

Aspects include obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary.

### FIELD OF THE DISCLOSURE

The subject disclosure relates to apparatuses and methods for facilitating a mobility aware traffic handling for communication networks and systems.

### BACKGROUND

The rapid evolution of wireless communication networks has led to a proliferation of mobile technologies that support high-speed data and voice services. Modern networks depend on mechanisms to manage user mobility. In these systems, mobility events—transitions made to maintain connection quality as users move within or between coverage areas—are important. Operators strive to ensure that users maintain uninterrupted connectivity while navigating complex network environments. However, the dynamic nature of these networks presents challenges in reliably satisfying user needs while maintaining efficient resource allocation.

Efficient network operation in mobile communication systems is essential for delivering a quality user experience. Operators aim to optimize connectivity, balancing the need for maintaining strong, stable links with the pressing requirement to conserve network resources. In many instances, decisions regarding user mobility are made based on instantaneous measurements of signal quality, interference levels, and current loading conditions. The primary objective is to maximize session throughput, minimize call drops, and reduce unnecessary signaling overhead. Thus, the design and configuration of mobility event parameters are important to achieving the delicate balance between responsiveness and stability in rapidly changing wireless environments.

A significant challenge faced by current networks is the tendency to manage mobility events using a uniform approach that does not consistently account for the specific operational environment of each user. Many systems trigger handover actions solely by monitoring network conditions, such as signal strength and capacity thresholds. This reactive strategy can be overly aggressive in situations where such events may not be necessary. The inability to differentiate between high-mobility and low-mobility scenarios can lead to the triggering of more mobility events than is required. As a result, this can impose additional overhead, degrade overall network performance, and reduce the quality of the end-user experience.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a diagram illustrating an example, non-limiting embodiment of a for facilitating a handover in accordance with various aspects described herein.

FIG. 2B depicts an illustrative embodiment of a method in accordance with various aspects described herein.

FIG. 2C depicts options for handling traffic as part of a handover in accordance with a first priority scheme.

FIG. 2D depicts options for handling traffic as part of a handover in accordance with a second priority scheme.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for apparatuses and methods that facilitate a mobility aware traffic handling for communication networks and systems. For example, aspects of this disclosure provide for differentiated treatment of communication devices (and associated traffic) based on whether the communication device is mobile or (largely) stationary. Other embodiments are described in the subject disclosure.

One or more aspects of the subject disclosure include, in whole or in part, obtaining first data indicative of a first location of a first user equipment; obtaining second data indicative of a second location of the first user equipment; obtaining third data indicative of a first transmit power level utilized by the first user equipment; obtaining fourth data indicative of a second transmit power level utilized by the first user equipment; determining, based on the first data and the second data, that the first user equipment has changed location in an amount less than a first threshold, resulting in a first determination; determining, based on the third data and the fourth data, that the first user equipment has changed a transmission power level that is utilized in an amount that is less than a second threshold, resulting in a second determination; and based on the first determination and the second determination, declaring that the first user equipment is stationary.

One or more aspects of the subject disclosure include, in whole or in part, determining that a count of client devices located within a geographical region of coverage associated with a network is greater than a threshold, resulting in a first determination; determining, based on the first determination, that a first client device included in the client devices is mobile, resulting in a second determination; determining, based on the first determination, that a second client device included in the client devices is stationary, resulting in a third determination; handling a first communication session involving the first client device in accordance with the second determination; and handling a second communication session involving the second client in accordance with the third determination, wherein the handling of the second communication session is different from the handling of the first communication session in terms of a potential handover of the respective communication session.

One or more aspects of the subject disclosure include, in whole or in part, determining, by a processing system including a processor, that a user equipment is in an active mode, resulting in a first determination; determining, by the processing system and based on the first determination, that the user equipment is stationary with respect to one or more thresholds, resulting in a second determination; and prioritizing, by the processing system and based on the second determination, maintaining a first communication session involving the user equipment and first network infrastructure on the first network infrastructure relative to a second communication session involving a second user equipment and the first network infrastructure on the first network infrastructure.

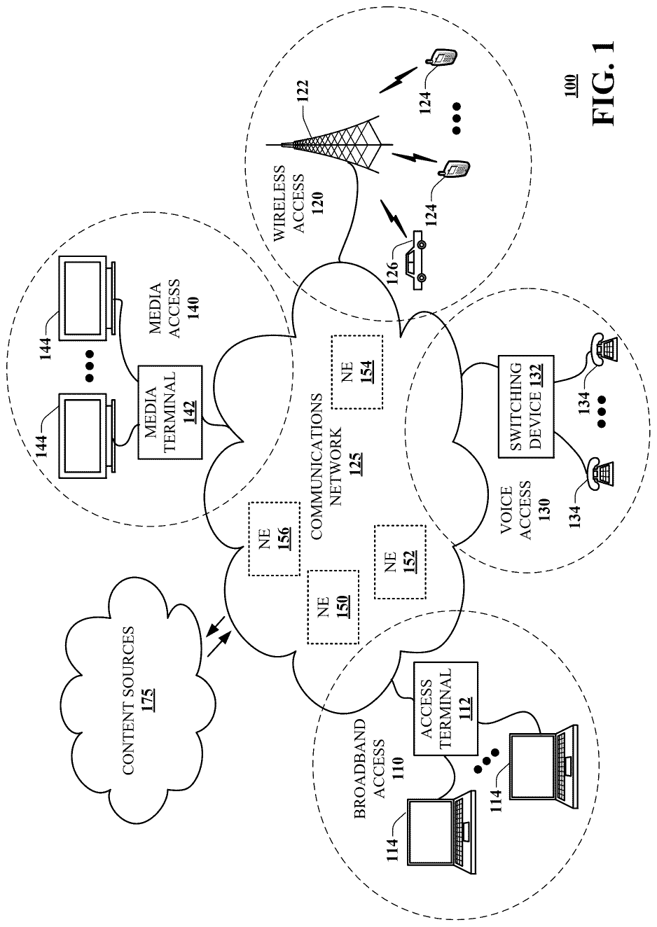

Referring now to FIG. 1, a block diagram is shown illustrating an example, non-limiting embodiment of a system 100 in accordance with various aspects described herein. For example, the system 100 can facilitate, in whole or in part, obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary. The system 100 can facilitate, in whole or in part, determining that a count of client devices located within a geographical region of coverage associated with a network is greater than a threshold, resulting in a first determination, determining, based on the first determination, that a first client device included in the client devices is mobile, resulting in a second determination, determining, based on the first determination, that a second client device included in the client devices is stationary, resulting in a third determination, handling a first communication session involving the first client device in accordance with the second determination, and handling a second communication session involving the second client in accordance with the third determination, wherein the handling of the second communication session is different from the handling of the first communication session in terms of a potential handover of the respective communication session. The system 100 can facilitate, in whole or in part, determining, by a processing system including a processor, that a user equipment is in an active mode, resulting in a first determination, determining, by the processing system and based on the first determination, that the user equipment is stationary with respect to one or more thresholds, resulting in a second determination, and prioritizing, by the processing system and based on the second determination, maintaining a first communication session involving the user equipment and first network infrastructure on the first network infrastructure relative to a second communication session involving a second user equipment and the first network infrastructure on the first network infrastructure.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, and as described above, many conventional systems trigger handover actions in respect of voice communication or data sessions solely by monitoring network conditions, such as signal strength and capacity thresholds. This reactive strategy can be overly aggressive in situations where such events may not be necessary. In densely populated or high-traffic areas (as potentially expressed relative to one or more thresholds), the practical implications become even more pronounced. Static or low-mobility users (or, analogously, communication devices or client devices/user equipment) may inadvertently prompt a series of unnecessary network transitions, despite remaining in proximity to their respective, optimal serving cell or infrastructure. These excessive transitions can lead to a degradation in service quality through dropped sessions and inefficient use of a network control plane signaling. The challenge may be compounded by the fact that network resource management may need to accommodate a wide range of user behaviors under variable conditions. It is understood and appreciated by this disclosure that addressing these issues requires a deeper understanding of the constraints imposed by conventional mobility management, which often falls short when dealing with densely occupied environments where user mobility may be limited.

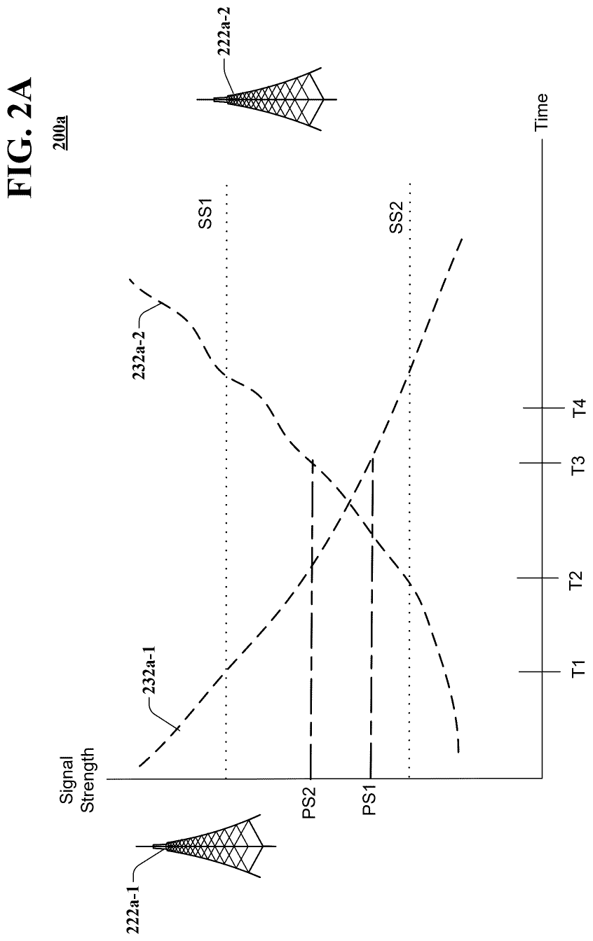

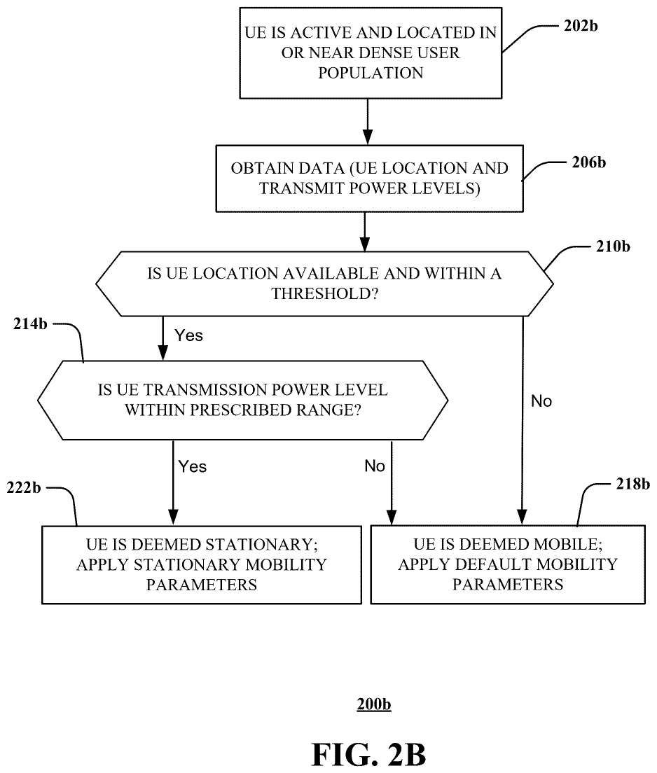

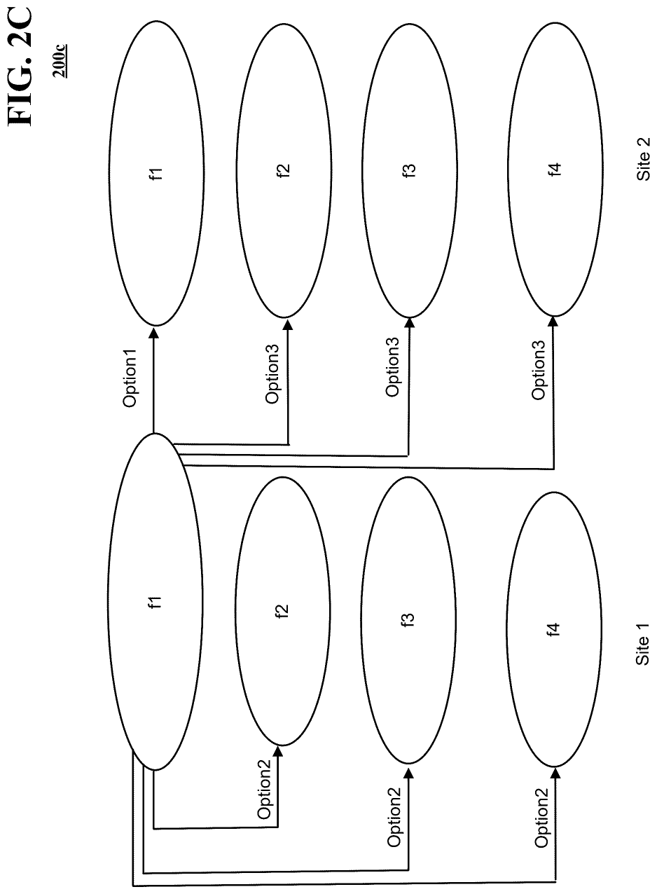

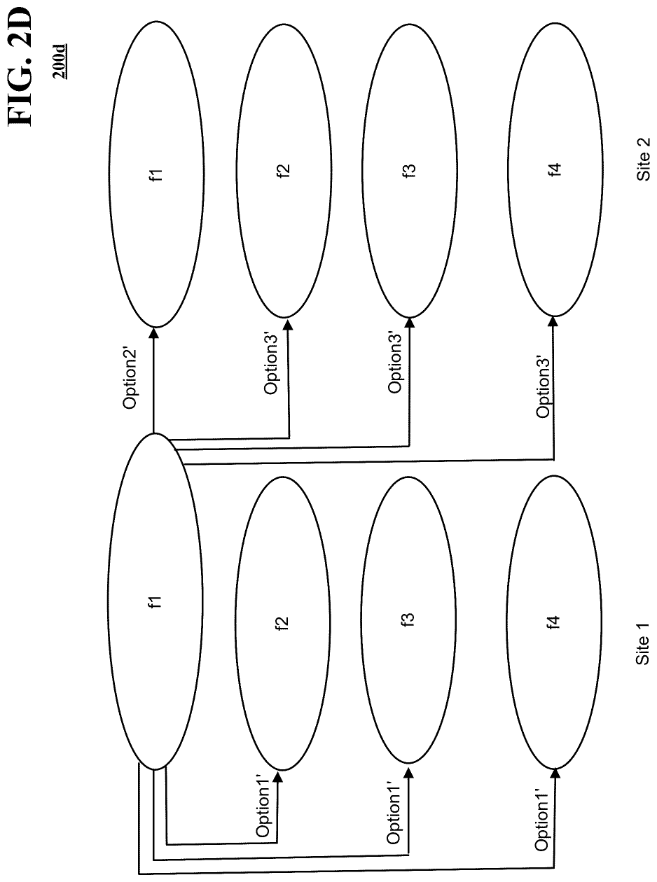

With reference now to FIG. 2A, a system diagram 200a mapping signal strength (on the vertical axis) relative to time (on the horizontal axis) is shown in respect of two network/system infrastructures-e.g., a first base station 222a-1 and a second base station 222a-2. In some embodiments, aspects of the system 200a may be included or incorporated as part of the system 100 of FIG. 1. For purposes of the system 200a, it may be assumed that a user equipment (UE) (not shown in FIG. 2A; see, e.g., a UE 124 in FIG. 1) initially obtains service via the first base station 222a-1 and then subsequently obtains service via the second base station 222a-2, in conjunction with a handover operation as described in further detail below.

The signal strength value may correspond to a signal strength as detected/measured by the UE in respect of each of the first base station 222a-1 and the second base station 222a-2. In this regard, a first curve/plot 232a-1 may correspond to a signal strength of signals emitted by the first base station 222a-1 as detected by the UE and a second curve-plot 232a-2 may correspond to a signal strength of signals emitted by the second base station 222a-2 as detected by the UE.

Two reference thresholds in terms of signal strength are represented in the diagram 200a of FIG. 2A. A first signal strength threshold (SS1) may represent a situation where a communication service (e.g., a voice call) involving the UE and facilitated by first base station 222a-1 “is in trouble”. As used in this context, the communication service being in trouble may denote that a quality of the communication service may degrade below an acceptable quality level as signal strength levels/values below SS1. A second signal strength threshold (SS2) may represent a situation/condition where the signal strength associated with a neighbor cell/infrastructure (e.g., the second base station 222a-2) is sufficiently strong to be considered for use in respect of the communication service involving the UE.

Thus, in the particular scenario depicted in FIG. 2A, the signal strength associated with the first curve 232a-1 dips below the first signal strength threshold SS1 at a time T1. Thereafter, at a time T2, the signal strength associated with the second curve 232a-2 exceeds the second signal strength threshold SS2 (however, the signal strength associated with the first curve 232a-1 is still greater than the signal strength associated with the second curve 232a-2 at the time T2). Subsequently, at a time T3, the signal strength detected/measured by the UE and associated with the second curve 232a-2/second base station 222a-2 may be greater than the signal strength detected/measured by the UE and associated with the first curve 232a-1/first base station 222a-1 (by some offset/threshold amount as represented by the difference between signal strength PS2 and signal strength PS1 in FIG. 2A), which may warrant a handoff/handover of the communication service from the first base station 222a-1 to the second base station 222a-2 (following some offset time—referred to herein as time to trigger—represented by the difference between time T4 and time T3 in FIG. 2A, which is to say that the handover may actually occur at the time T4).

It should be kept in mind that signal strength is representative of one parameter that may influence whether a handover occurs. Other parameters, such as network or cell loading, capacity, etc., may similarly drive decisions as to whether a handover should occur.

In general, conventional networks may attempt to keep a communication device (e.g., a UE) on a same frequency band and handover a communication service or session to another serving cell (intrafrequency), rather than handover the session to a new frequency band on the same site or a neighboring site (interfrequency). This may generally be representative of a good philosophical approach, as communication devices may be mobile, moving throughout the spatial area/region served by the network infrastructure. As UEs move away from a first network infrastructure and towards another network infrastructure, it follows logically that the best strategy may be to handover from one to the other on a common frequency/frequency band. Electromagnetic path loss reduces signal strength of communication signals as a function of distance. Candidates for handover may be determined by scanning measurements taken by a communication device and shared with network infrastructure. If no neighbors can be found that satisfy specified criteria, the communication service or session may stay on a serving cell/infrastructure, until the user ends the communication service/session, moves spatially closer to another network infrastructure, or the communication service/session drops/fails.

A radio in a communication device can easily scan the frequency band that it is currently tuned to. For example, if a communication session is currently served by Cell A on Band 2 (1900 MHz PCS), then the radio can scan all nearby 1900 MHz PCS servers without tuning the receiver to a different band. This is an advantage of intrafrequency handovers. For interfrequency handovers, the radio must tune to the other frequency/frequencies in to scan the available handover candidates. This tuning takes additional time and consumes resources which could be used to transfer data (e.g., a payload). So, in general and all other conditions being assumed equal, intrafrequency handovers may be preferred and may be the first type of handovers generally attempted to remedy a quality problem in respect of a communication service or session.

In some situations, it is possible that mobility events may result in a negative experience of a user (or, analogously, a UE/client device). For example, it may be the case that, initially and at a first point in time, a communication service or session involving a UE is serviced via first network infrastructure (e.g., a first base station). However, due to loading of the first network infrastructure it may be necessary to transfer or handover the communication service/session to second network infrastructure (e.g., a second base station). Thereafter, and due to quality-based conditions, it may be the case that the communication service/session is progressively handed over to additional network infrastructures (e.g., a third base station, followed by a fourth base station, etc.) that may be (progressively more) distant from the location of the UE. Each handover decision may be based upon network conditions (e.g., quality and loading), and might not take into consideration whether, and to what extent, the UE is mobile/moving (or, analogously, whether and to what extent the UE is (generally) stationary). However, it is appreciated by this disclosure that enhanced decision-making processes may factor the degree or extent of UE mobility into determinations of whether to handover a communication service or session. In this respect, and as described in further detail below, aspects of this disclosure provide: (1) a computational technique to determine whether a user/UE is mobile, (2) an identification of alternative network parameters to attempt to encourage the user/UE to stay on the nearest, best sector (intra) despite other criteria that would traditionally make it handover (inter), and (3) a way to offload other, higher mobility traffic instead of low mobility traffic.

In terms of determining whether a UE is mobile, UE power control is a feature present in all modern wireless networks. UE power control is used to reduce interference and preserve battery life. UE power control is used primarily in an active mode, once a connection involving a UE has been established, to determine at which power level the UE should transmit. To facilitate the determination of the power level, the UE takes measurements of the signal power received from network infrastructure (e.g., a base station) and reports the values back through uplink (UL) control messages. The network infrastructure compares the values to a lookup range of values and responds with a target power level that the UE is to utilize. In this manner, noise on a receiver at the network infrastructure may be reduced (e.g., minimized) as all UEs in the service area/region may be kept at the lowest power levels possible while still attempting to satisfy QoS or key performance metrics. The network infrastructure may record UE transmit (TX) power for each UE whenever it is reported. Generally, UE TX power can be assumed to be proportional to the distance from the network infrastructure/cell site—e.g., the higher the power level that is used, the closer the UE may be to an edge/perimeter of a cell serving radius.

Since at least LTE Release 7, the MME (Mobility Management Entity) in LTE systems has had an ability to ask the network infrastructure to report the location of the UE. This initiated the creation of location-based services (LBS). If a UE has the capability of providing a GPS based location—as recorded in its home subscriber server (HSS) entry—the MME may send a location report request to the network infrastructure. The network infrastructure may pass the request (NAS stratum type) along to the UE encapsulated within a downlink (DL) control message on, e.g., a dedicated control channel (DCCH). The UE may respond with the requested information in a UL control message. The network infrastructure may then pass this data back to the MME in NAS format for use in LBS and e911 services. In this position reporting protocol both the network infrastructure and the MME have access to the UE location information.

It is noted that the UE transmission power levels that are used and/or the reported/determined (GPS) location of the UE, may be analyzed or assessed over time to determine the amount or extent that the UE is mobile (or, analogously, the amount or extent that the UE is stationary). Aspects of this disclosure may introduce a new metric/parameter, illustratively referred to herein as MOBILITYSTATE, that may signify whether a UE is moving or reliably stationary. To facilitate a use of MOBILITYSTATE, each radio equipment manufacturer (OEM) may define a new table in existing databases which captures user data. A historical trend of UE location and UE transmission power levels may need to be stored because the analysis may be defined as a delta analysis, which presumes knowledge of previous state as well as current state, for comparison. Initial UE location at the start of a connection (e.g., a RRC connection) or active session may be used to create a virtual geo-fence corresponding to/defining a radius within which the UE may move while still being considered ‘stationary’. Each new reported location (as may be specified using latitude and longitudinal coordinates) of the UE may be analyzed for radial distance from the initial location at the start of the connection. If, during the active session, the UE never exceeds a predetermined threshold distance from the initial location, the session may be tagged as stationary and treated differently with respect to mobility event parameters in the network control elements. As soon as the UE leaves the immediate vicinity (e.g., as soon as the UE exceeds the radius), the UE may be tagged/flagged as ‘mobile’ and default mobility event parameters may apply. A predefined timer may be used to allow a long duration session to change state from stationary to mobile, or vice versa. A look-back window function may be used to change the initial location, thus enabling a dynamic delta analysis for this purpose.

There may be cases where the UE position is relatively static, but the UE may need a mobility event to save a session from deteriorating radio conditions. This could occur due to the UE moving indoors or rising interference levels, for example. In this case, knowledge of the trend in UE transmission power levels may aid the accuracy of the determination. UE transmission power levels may serve as a strong proxy for the link budget between the UE and the network infrastructure, critically influenced by distance. As the link budget deteriorates, the UE may report lower received power (RSRP) from the network infrastructure and the network, in response, may inform the UE to increase transmission power to balance the link and maintain the connection.

If GPS reporting is lost, it may mean that the UE location and/or the link budget has likely changed. A few assumptions could be made: the UE has gone indoors, or the UE has moved to a very different area of topography with no view of the horizon for GPS reception. Both conditions may lead to a conclusion that the UE may need a mobility event to save the session from declining quality in the very near future, so it may be desirable for the UE to operate using traditional mobility governance. The analysis may utilize user-configurable timers to tailor the length of GPS outage or rapidity of power change that can be tolerated with the UE still being considered stationary. Positive GPS location reporting and relatively static UE transmission power levels may both be considered necessary for assigning MOBILITYSTATE=0 (e.g., stationary) for purposes of this disclosure; otherwise, MOBILITYSTATE may be set equal to 1 (e.g., an assumption may be made that the UE is mobile in the absence of a positive confirmation that the UE is stationary).

In view of the foregoing, reference may now be made to FIG. 2B, which depicts an illustrative embodiment of a method 200b in accordance with various aspects described herein. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 202b, a determination may be made that a UE is in an active mode and is located in a dense urban area or is in proximity to an outdoor event venue (e.g., the UE is in an environment corresponding to a dense user base). Indeed, it is appreciated that if the UE is in an idle mode or is located in a sparsely populated area/region (as potentially expressed relative to one or more thresholds) that conventional techniques for facilitating handover determinations may be utilized, and the method 200b may end at the point of block 202b.

In block 206b, data associated with the UE may be obtained. For example, the data may include a reported location of the UE (e.g., a GPS location) and transmission power levels that are utilized by the UE. The data may include, or be associated with, respective timestamps to signify/indicate when the associated sample or measurement included in the data was obtained.

In block 210b, a determination may be made whether the reported UE location is available and the reported UE location is within a threshold distance (relative to an initially reported UE location or some other location included as part of a sliding window as described above). If so, flow may proceed to block 214b; otherwise, flow may proceed to block 218b.

In block 214b, a determination may be made whether the UE transmission power levels are within a prescribed range. The prescribed range may be based on an initial power level that is used, or an adjusted power level for long duration services/sessions as described above. If the determination of block 214b is answered in the affirmative, flow may proceed to block 222b; otherwise, flow may proceed to block 218b.

In block 218b, the value of MOBILITYSTATE may be set equal to 1, signifying that the UE is to be treated as being ‘mobile’. As part of block 218b, and based on the value of MOBILITYSTATE being equal to 1, default mobility parameters may be applied in relation to whether to handover a communication service/session involving the UE.

In block 222b, the value of MOBILITYSTATE may be set equal to 0, signifying that the UE is to be treated as being ‘stationary’. As part of block 222b, and based on the value of MOBILITYSTATE being equal to 0, stationary mobility parameters may be applied in relation to whether to handover the communication service/session involving the UE.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Having just described techniques for determining whether a UE is deemed to be mobile or stationary, techniques will now be considered for facilitating an identification of alternative network parameters to attempt to encourage the UE to stay on the nearest, best sector (intra) despite other criteria that would traditionally make it handover (inter) as referenced above. Conventionally, mobility parameters exist which control UE movement between sites and frequency bands based on the needs of the UE. The parameters are a flexible set of variables that allow an engineer/operator to tailor the parameters based on what the engineer/operator believes is best for the user experience. In practice, mobile network operators (MNOs) implement these parameters as a standard, based upon trials and best practices that have been observed over time. When a chronic detractor condition is found to be hurting quality of service, however, engineers may tailor settings in a specific area to change the UE behavior and reduce (e.g., eliminate) the detractor condition.

Because of an assumption that a user/UE is mobile, and to reduce a utilization of resources for facilitating measurements for interfrequency handovers, operators may strongly prefer in-band handovers between independent cell sites as the first curative attempt to improve a degrading user experience. This works well for mobile traffic and has increased capacity of networks where it has been implemented. If a UE is moving away from a first infrastructure, and towards a neighbor, second infrastructure, at some point it makes little sense to try and have the UE stay on the first infrastructure.

However, the foregoing behavior may impose a degree of harm in that a stationary user/UE might be better off experiencing a handover between different frequency bands on the same serving site/infrastructure. If handover decision-making is biased towards preferring intrafrequency handovers, then the distance to the serving site/infrastructure may increase with each successive handover action. It is appreciated as part of this disclosure that it may be desirable to keep the stationary user/UE served by its nearest site/infrastructure.

The parameters which control the type of handover that is attempted, and how quickly it is attempted, may be defined uniquely for each frequency band in each sector of a cell site. So, an opportunity is provided/realized to customize or tailor the behavior of each radio, enabling a network operator to choose whether to hold onto, or shed, traffic on a per radio basis.

As described above in respect of FIG. 2B, aspects of this disclosure enable an alternate/stationary set of parameters (see, e.g., block 222b) to be used that may mirror an existing set of default mobility parameters (see, e.g., block 218b). The alternate/stationary parameters may be used as a substitute for governing the UE behavior when the UE is determined to be stationary (e.g., representative of conditions where MOBILITYSTATE=0 as described above). To achieve this, OEMs may electively implement respective sets of parameters in the coding of their infrastructure software. In doing so, the coding would provide engineers or network operators greater control and flexibility over whether to bias a UE to stay on a carrier or frequency band, or leave quickly, based on mobility status (e.g., whether the UE is deemed stationary or mobile as described above).

To demonstrate aspects of the foregoing, reference may now be made to FIG. 2C and FIG. 2D. FIG. 2C illustrates aspects of a traditional handover priority scheme 200c, whereas FIG. 2D illustrates aspects of a handover priority scheme 200d in accordance with aspects of this disclosure, and in particular, aspects of a handover priority scheme for a stationary UE.

In FIG. 2C, four frequencies/frequency bands are denoted for a first site (Site 1) as f1, f2, f3, and f4. Similarly, a second site (Site 2) may support the same four frequency bands f1, f2, f3, and f4. It may be assumed that in FIG. 2C that a UE is (currently) being serviced via the first frequency/frequency band f1 of Site 1. In the event that a handover is deemed necessary, the order of preference for the handover that may be utilized may correspond to: (1) option 1, (2) next, option 2, and (3) finally, option 3. As shown in FIG. 2C, option 1 may correspond to an intrafrequency, intersite handover from f1 of Site 1 to f1 of Site 2; option 2 may correspond to an interfrequency, intrasite handover from f1 of Site 1 to one of f2, f3, or f4 of Site 1; and option 3 may correspond to an interfrequency, intersite handover from f1 of Site 1 to one of f2, f3, or f4 of Site 2.

In FIG. 2D, four frequencies/frequency bands are denoted for a first site (Site 1) as f1, f2, f3, and f4. Similarly, a second site (Site 2) may support the same four frequency bands f1, f2, f3, and f4. It may be assumed that in FIG. 2D that a UE is (currently) being serviced via the first frequency/frequency band f1 of Site 1. In the event that a handover is deemed necessary, the order of preference for the handover that may be utilized may correspond to: (1) option 1′, (2) next, option 2′, and (3) finally, option 3′. As shown in FIG. 2D, option 1′ may correspond to an interfrequency, intrasite handover from f1 of Site 1 to one of f2, f3, or f4 of Site 1; option 2′ may correspond to an intrafrequency, intersite handover from f1 of Site 1 to f1 of Site 2; and option 3′ may correspond to an interfrequency, intersite handover from f1 of Site 1 to one of f2, f3, or f4 of Site 2.

Thus, as shown in FIG. 2D, aspects of this disclosure may promote/prioritize an interfrequency, intrasite handover (option 1′) relative to an intrafrequency, intersite handover (option 2′) for a stationary UE. This is the opposite situation from the priority scheme (e.g., option 1: intrafrequency, intersite handover, followed by option 2: interfrequency, intrasite handover) shown in respect of FIG. 2C.

Aspects of this disclosure, inclusive of aspects set forth above, recognize an inherent advantage in that network efficiency depends on keeping UEs served by the nearest infrastructure that enables the lowest power levels possible to be used. Indeed, by lowering the power level associated with a given device (e.g., a given UE), the performance of an entire network may benefit. That said, it is understood and appreciated that if low-mobility (e.g., stationary UE) traffic is biased to stay on a particular serving infrastructure, quality may degrade if that serving infrastructure congests due to capacity constraints/limits. As such, a similar methodology may be adopted to encourage high-mobility traffic (e.g., a highly-mobile UE) to be offloaded to alternative infrastructure (from a current, serving infrastructure).

In this respect, and as described above, if a UE was determined to be ‘stationary’ (e.g., a condition of MOBILITYSTATE=0), the infrastructure would apply parameters aimed at discouraging handover to another site, therefore encouraging the UE to stay on the current serving site. Similarly, if the UE mobility state were judged to be mobile (e.g., a condition of MOBILITYSTATE=1), then the infrastructure would use default parameters which allowed normal/conventional mobility handovers to occur. This arrangement may be taken one step further by altering the default mobility parameters to encourage the rapid exit of high-mobility traffic off/away from a current, serving infrastructure. For example, engineers may select parameter values such that traffic associated with a highly-mobile UE may be quicky routed from a current, serving infrastructure to alternative infrastructure so that traffic associated with a low-mobile/stationary UE can complete transactions and fall back to an idle state/condition. Proceeding in this manner would tend to free up resources to be used again quickly by a next UE session/service request.

In view of the foregoing, parameter values that may be considered to encourage traffic associated with a highly-mobile UE to be quicky routed from a current, serving infrastructure to alternative infrastructure may include: (1) a trigger value, (2) a time to trigger, and (3) a hysteresis value. In particular, the trigger value may correspond to a received signal power (e.g., RSRP) detected by the UE, and setting this value to be a large value may encourage handovers to occur sooner than they might otherwise occur. The time to trigger value may be shortened to increase the probability of a handover happening. Any sort of hysteresis or offset/bias for maintaining a connection with the serving infrastructure may be made small to allow for more handovers to occur.

As demonstrated herein, aspects of this disclosure may facilitate network optimization (e.g., radio access network optimization) operations. Indeed, aspects of this disclosure may enhance the user or customer/subscriber experience, which in turn may reduce churn and increase brand reputation/loyalty. Furthermore, from a technical perspective, aspects of this disclosure may tend to increase average throughput, reduce interference, and reduce session failures/drops, thereby representing substantial improvements in relation to practical applications involving a provisioning of communication services or sessions. Additionally, aspects of this disclosure may tend to reduce the number or frequency of handovers that occur. As one skilled in the art will appreciate, from the perspective of a network/system operator or service provider handovers, in some sense, represent a penalty in terms of the overhead that is required to facilitate a handover. Thus, by reducing the count of handovers the attendant penalty may be reduced.

As demonstrated herein, the various aspects of this disclosure are not directed to abstract ideas. To the contrary, the various aspects of this disclosure are directed to, and encompass, significantly more than any abstract idea standing alone. Indeed, the various aspects of this disclosure facilitate a generation of useful, concrete, tangible and transformative results in respect of a multitude of practical applications.

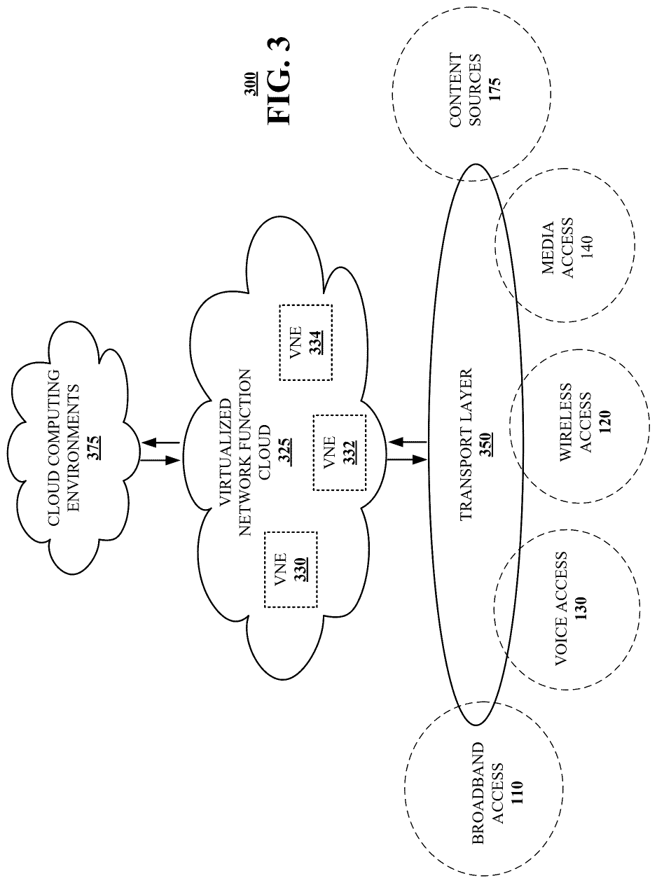

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system/diagram 200a, and method 200b presented in FIGS. 1, 2A, and 2B. For example, the virtualized communication network 300 can facilitate, in whole or in part, obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary. The virtualized communication network 300 can facilitate, in whole or in part, determining that a count of client devices located within a geographical region of coverage associated with a network is greater than a threshold, resulting in a first determination, determining, based on the first determination, that a first client device included in the client devices is mobile, resulting in a second determination, determining, based on the first determination, that a second client device included in the client devices is stationary, resulting in a third determination, handling a first communication session involving the first client device in accordance with the second determination, and handling a second communication session involving the second client in accordance with the third determination, wherein the handling of the second communication session is different from the handling of the first communication session in terms of a potential handover of the respective communication session. The virtualized communication network 300 can facilitate, in whole or in part, determining, by a processing system including a processor, that a user equipment is in an active mode, resulting in a first determination, determining, by the processing system and based on the first determination, that the user equipment is stationary with respect to one or more thresholds, resulting in a second determination, and prioritizing, by the processing system and based on the second determination, maintaining a first communication session involving the user equipment and first network infrastructure on the first network infrastructure relative to a second communication session involving a second user equipment and the first network infrastructure on the first network infrastructure.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

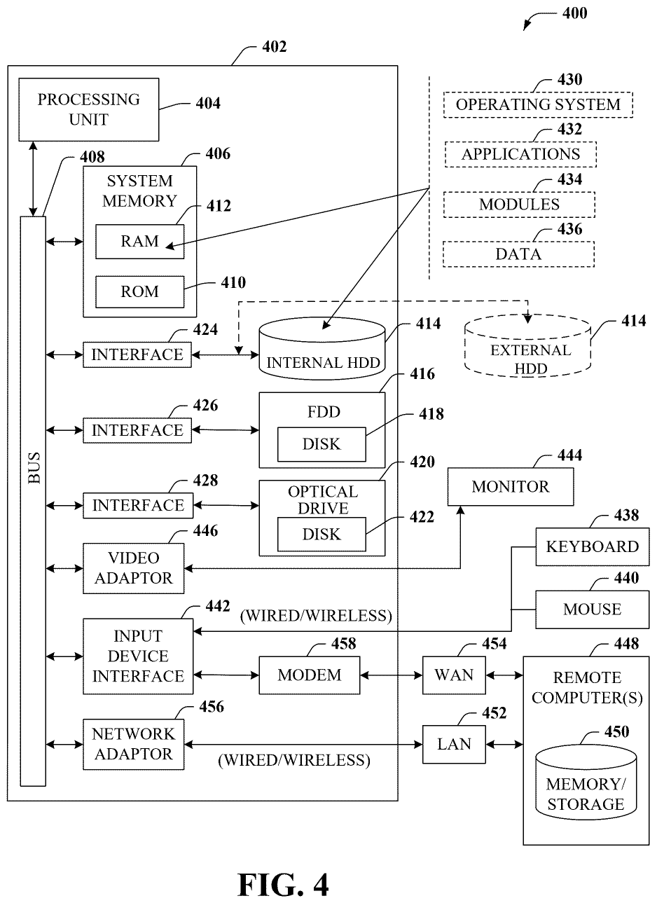

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary. The computing environment 400 can facilitate, in whole or in part, determining that a count of client devices located within a geographical region of coverage associated with a network is greater than a threshold, resulting in a first determination, determining, based on the first determination, that a first client device included in the client devices is mobile, resulting in a second determination, determining, based on the first determination, that a second client device included in the client devices is stationary, resulting in a third determination, handling a first communication session involving the first client device in accordance with the second determination, and handling a second communication session involving the second client in accordance with the third determination, wherein the handling of the second communication session is different from the handling of the first communication session in terms of a potential handover of the respective communication session. The computing environment 400 can facilitate, in whole or in part, determining, by a processing system including a processor, that a user equipment is in an active mode, resulting in a first determination, determining, by the processing system and based on the first determination, that the user equipment is stationary with respect to one or more thresholds, resulting in a second determination, and prioritizing, by the processing system and based on the second determination, maintaining a first communication session involving the user equipment and first network infrastructure on the first network infrastructure relative to a second communication session involving a second user equipment and the first network infrastructure on the first network infrastructure.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

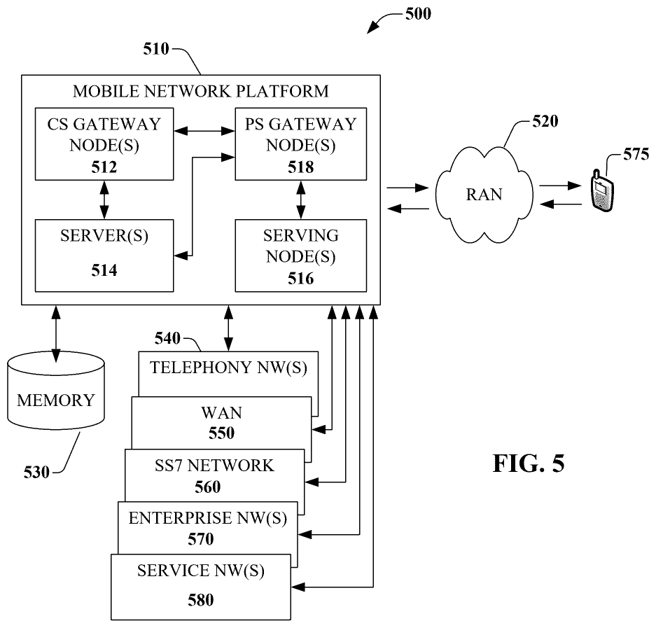

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary. The platform 510 can facilitate, in whole or in part, determining that a count of client devices located within a geographical region of coverage associated with a network is greater than a threshold, resulting in a first determination, determining, based on the first determination, that a first client device included in the client devices is mobile, resulting in a second determination, determining, based on the first determination, that a second client device included in the client devices is stationary, resulting in a third determination, handling a first communication session involving the first client device in accordance with the second determination, and handling a second communication session involving the second client in accordance with the third determination, wherein the handling of the second communication session is different from the handling of the first communication session in terms of a potential handover of the respective communication session. The platform 510 can facilitate, in whole or in part, determining, by a processing system including a processor, that a user equipment is in an active mode, resulting in a first determination, determining, by the processing system and based on the first determination, that the user equipment is stationary with respect to one or more thresholds, resulting in a second determination, and prioritizing, by the processing system and based on the second determination, maintaining a first communication session involving the user equipment and first network infrastructure on the first network infrastructure relative to a second communication session involving a second user equipment and the first network infrastructure on the first network infrastructure.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

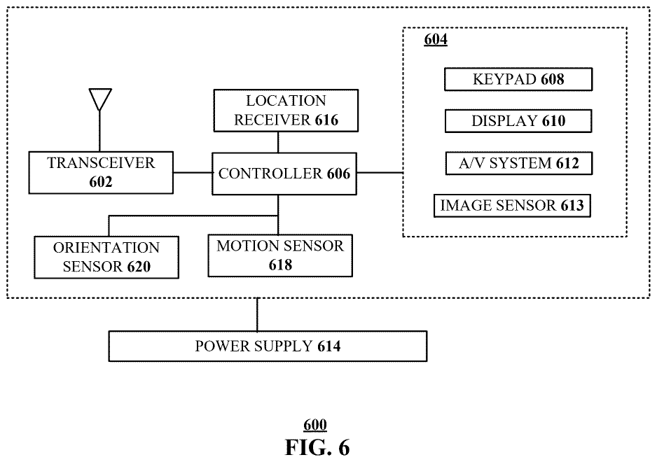

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining first data indicative of a first location of a first user equipment, obtaining second data indicative of a second location of the first user equipment, obtaining third data indicative of a first transmit power level utilized by the first user equipment, obtaining fourth data indicative of a second transmit power level utilized by the first user equipment, determining, based on the first data and the second data, that the first user equipment has changed location in an amount less than a first threshold, resulting in a first determination, determining, based on the third data and the fourth data, that the first user equipment has changed a transmission power level that is utilized in an amount that is less than a second threshold, resulting in a second determination, and based on the first determination and the second determination, declaring that the first user equipment is stationary. The computing device 600 can facilitate, in whole or in part, determining that a count of client devices located within a geographical region of coverage associated with a network is greater than a threshold, resulting in a first determination, determining, based on the first determination, that a first client device included in the client devices is mobile, resulting in a second determination, determining, based on the first determination, that a second client device included in the client devices is stationary, resulting in a third determination, handling a first communication session involving the first client device in accordance with the second determination, and handling a second communication session involving the second client in accordance with the third determination, wherein the handling of the second communication session is different from the handling of the first communication session in terms of a potential handover of the respective communication session. The computing device 600 can facilitate, in whole or in part, determining, by a processing system including a processor, that a user equipment is in an active mode, resulting in a first determination, determining, by the processing system and based on the first determination, that the user equipment is stationary with respect to one or more thresholds, resulting in a second determination, and prioritizing, by the processing system and based on the second determination, maintaining a first communication session involving the user equipment and first network infrastructure on the first network infrastructure relative to a second communication session involving a second user equipment and the first network infrastructure on the first network infrastructure.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first data indicative of a first location of a first user equipment;
obtaining second data indicative of a second location of the first user equipment;
obtaining third data indicative of a first transmit power level utilized by the first user equipment;
obtaining fourth data indicative of a second transmit power level utilized by the first user equipment;
determining, based on the first data and the second data, that the first user equipment has changed location in an amount less than a first threshold, resulting in a first determination;
determining, based on the third data and the fourth data, that the first user equipment has changed a transmission power level that is utilized in an amount that is less than a second threshold, resulting in a second determination; and
based on the first determination and the second determination, declaring that the first user equipment is stationary.

2. The device of claim 1, wherein the operations further comprise:
based on the declaring that the first user equipment is stationary, applying a first set of mobility parameters that dictate whether a first communication session involving the first user equipment is handed off.

3. The device of claim 2, wherein the operations further comprise:
obtaining fifth data indicative of a first location of a second user equipment;
obtaining sixth data indicative of a second location of the second user equipment;
and determining, based on the fifth data and the sixth data, that the second user equipment has changed location in an amount greater than the first threshold, resulting in a third determination.

4. The device of claim 3, wherein the operations further comprise:
based on the third determination, declaring that the second user equipment is mobile.

5. The device of claim 4, wherein the operations further comprise:
based on the declaring that the second user equipment is mobile, applying a second set of mobility parameters that dictate whether a second communication session involving the second user equipment is handed off.

6. The device of claim 5, wherein values for the second set of mobility parameters are at least partially different from values for the first set of mobility parameters.

7. The device of claim 2, wherein the first set of mobility parameters pertains to:
received signal strength, loading, capacity, time to trigger, hysteresis, or any combination thereof.

8. The device of claim 2, wherein the operations further comprise:
obtaining fifth data indicative of a first transmit power level utilized by a second user equipment;
obtaining sixth data indicative of a second transmit power level utilized by the second user equipment; and
determining, based on the fifth data and the sixth data, that the second user equipment has changed a transmission power level that is utilized in an amount that is greater than the second threshold, resulting in a third determination.

9. The device of claim 8, wherein the operations further comprise:
based on the third determination, declaring that the second user equipment is mobile; and
based on the declaring that the second user equipment is mobile, applying a second set of mobility parameters that dictate whether a second communication session involving the second user equipment is handed off.

10. The device of claim 2, wherein the first set of mobility parameters that dictate whether a first communication session involving the first user equipment is handed off is included as part of a priority scheme.

11. The device of claim 10, wherein the priority scheme includes a plurality of priority levels, wherein a first, highest priority level of the plurality of priority levels corresponds to an intrasite, interfrequency handover, a second, next highest priority level of the plurality of priority levels corresponds to an intersite, infrafreuqency handover, and a third, lowest priority level of the plurality of priority levels corresponds to an intersite, interfrequency handover.

12. The device of claim 1, wherein the operations further comprise:
subsequent to the declaring that the first user equipment is stationary, obtaining fifth data indicative of a third location of the first user equipment;
determining, based on the second data and the fifth data, that the first user equipment has changed location in an amount greater than the first threshold, resulting in a third determination; and
based on the third determination, declaring that the first user equipment is mobile.

13. The device of claim 12, wherein the operations further comprise:
applying first criteria for handing over a first communication session involving the first user equipment when the first user equipment is stationary and applying second criteria for handing over a second communication session involving the first user equipment when the first user equipment is mobile, the second criteria being at least partially different from the first criteria.

14. The device of claim 1, wherein the operations further comprise:
subsequent to the declaring that the first user equipment is stationary, obtaining fifth data indicative of a third transmit power level utilized by the first user equipment;
determining, based on the fourth data and the fifth data, that the first user equipment has changed the transmission power level that is utilized in an amount that is greater than the second threshold, resulting in a third determination; and
based on the third determination, declaring that the first user equipment is mobile.

15. The device of claim 14, wherein the operations further comprise:
applying first criteria for handing over a first communication session involving the first user equipment when the first user equipment is stationary and applying second criteria for handing over a second communication session involving the first user equipment when the first user equipment is mobile, the second criteria being at least partially different from the first criteria.

16. A non-transitory machine-readable medium, comprising executable instructions that, when executed by a processing system including a processor, facilitate performance of operations, the operations comprising:
determining that a count of client devices located within a geographical region of coverage associated with a network is greater than a threshold, resulting in a first determination;
determining, based on the first determination, that a first client device included in the client devices is mobile, resulting in a second determination;
determining, based on the first determination, that a second client device included in the client devices is stationary, resulting in a third determination;
handling a first communication session involving the first client device in accordance with the second determination; and
handling a second communication session involving the second client in accordance with the third determination, wherein the handling of the second communication session is different from the handling of the first communication session in terms of a potential handover of the respective communication session.

17. The non-transitory machine-readable medium of claim 16, wherein the determining that the first client device is mobile comprises: determining that the first client device changes location in an amount greater than a first threshold within a first period of time, determining that the first client device changes a transmission power level in an amount greater than second threshold within a second period of time, or a combination thereof.

18. The non-transitory machine-readable medium of claim 17, wherein the determining that the second client device is stationary comprises: determining that the second client device changes location in an amount less than the first threshold within a third period of time and determining that the second client device changes a transmission power level in an amount less than the second threshold within a fourth period of time.

19. A method, comprising:
determining, by a processing system including a processor, that a user equipment is in an active mode, resulting in a first determination;
determining, by the processing system and based on the first determination, that the user equipment is stationary with respect to one or more thresholds, resulting in a second determination; and
prioritizing, by the processing system and based on the second determination, maintaining a first communication session involving the user equipment and first network infrastructure on the first network infrastructure relative to a second communication session involving a second user equipment and the first network infrastructure on the first network infrastructure.

20. The method of claim 19, wherein the prioritizing is further based on a third determination that the second user equipment is mobile with respect to the one or more thresholds, the method further comprising:
handing over, by the processing system, the second communication session to second network infrastructure in accordance with criteria pertaining to: signal strength detected by the second user equipment, first load accommodated by the first network infrastructure relative to a capacity of the first network infrastructure, and second load accommodated by the second network infrastructure relative to a capacity of the second network infrastructure.
